(19) United States
(12) Patent Application Publication
(10) Pub. No.: US 2009/0313780 A1
(43) Pub. Date: Dec. 24, 2009

(54) ADJUSTABLE SWIVELING T-HANDLE

(76) Inventor: John Martin, Irvine, CA (US)

Correspondence Address: KELLY LOWRY & KELLEY, LLP, 6320 CANOGA AVENUE, SUITE 1650, WOODLAND HILLS, CA, 91367, US

(21) Appl. No.: 12/141,347

(22) Filed: Jun. 18, 2008

(51) Int. Cl. A47L 13/02; A47L 13/022; B25G 1/06

(52) U.S. Cl. 15/236.01; 15/144.1; 81/489

(57) ABSTRACT

A hand tool with a handle that is configurable for free rotation or adjustable to multiple locking rotation positions. The handle includes a cylindrical bore and a faceted bore, each of which is configured to separately receive a faceted stem on a shaft of the tool. The cylindrical bore permits free rotation of the handle about the shaft. The faceted bore permits selectively adjustable locking rotation of the handle about the shaft.

### BACKGROUND OF THE INVENTION

The present invention relates to handles used primarily with scraping tools in the construction trade. More particularly, the invention relates to an adjustable swiveling handle for a hand-held manual scraper.

In certain construction trades involved with the installation of floor covering materials, such as carpet and tile, hand-held manual scraping tools are often used to remove adhered residue from floors as part of a final preparatory step. Heavier scraping tools, especially machine-driven scrapers, are often used to prepare large areas by removing old floor coverings and associated residue. However, it is often necessary to remove lesser amounts of residue, especially from relatively small areas such as in corners and under overhangs, which heavier scraping tools are unable to clear effectively. In addition, removal of residue from less rugged surfaces, such as interior walls, sometimes requires a more controllable, lighter and smaller tool.

To meet demand for lighter, more controllable scraping tools, various hand-held scrapers have been developed. One type of scraping tool, sometimes called a “T-handled scraper”, utilizes a thin, razor-like blade in a scraping position at the end of a shaft, which is typically about eighteen inches long. The scraping blade itself typically has a cutting edge about three to five inches long. At the other end of the shaft, an oblong handle is fixed to the shaft. The handle is configured to be grasped in the palm of one hand, with the shaft of the scraper passing between the fingers of the hand. With this type of scraper, a user can clean surfaces using a single hand, leaving the other hand free.

Considerable hand pressure may sometimes be required when using such a tool, which may cause hand or arm fatigue when the tool is used repeatedly. In addition, heavy use of a hand-held scraping tool may cause blisters on a user's hand, because of relative movement between the hand and the handle of the scraper. To overcome these concerns, prior art scrapers have included a handle that swivels freely around the shaft during use. A handle with such freedom of movement has been found to relieve strain on a user's arm and wrist, as well as reducing relative movement between the user's palm and the handle.

However, a handle with such freedom of movement may in some instances prove a detriment rather than a benefit. In some cases a user may find that a fixed handle may provide better leverage and greater ease of use in certain instances. In addition, there may be times where a fixed handle having an angle of rotation about the shaft different from that of the scraping blade may provide for greater ease of use.

Accordingly, there is a need for a new type of adjustable, swiveling handle that may at times freely rotate about the shaft of the tool and at other times be adjustable to a plurality of fixed rotational positions. This new type of handle would be less fatiguing to use and less likely to cause blisters during heavy use. The present invention satisfies these needs and provides other related advantages.

### SUMMARY OF THE INVENTION

The present invention is directed to a hand tool, preferably a scraper, comprising a tool head, a tool shaft, and a handle. The tool shaft has a first end which is attached to the tool head and a faceted second end to which the handle is attached.

The handle is selectively and adjustably attached to the second end of the tool shaft by a bore. The bore comprises a cylindrical first section for receiving the second end of the tool shaft in a manner permitting free rotation of the handle relative to the tool shaft. The bore also comprises a coaxial, faceted second section for alternatively receiving the second end of the tool shaft in a manner preventing free rotation of the handle relative to the tool shaft. A lock releasably secures the handle to the second end of the tool shaft.

The cylindrical first section of the bore defines a first interior shoulder and the faceted second section defines a second interior shoulder in the bore. The second end of the tool shaft defines an exterior shoulder. When the cylindrical first section of the bore receives the second end of the tool shaft, the first interior shoulder engages the exterior shoulder of the second end of the tool shaft. When the faceted second section receives the second end of the tool shaft, the second interior shoulder engages the exterior shoulder.

The handle may be made from plastic, reinforced plastic, die-cast metal or machined metal. Types of plastic may include nylon or ABS (acrylonitrile butadiene styrene) wherein the handle is metal may be made from aluminum coated with a rubberized plastic.

When the cylindrical first section receives the second end of the tool shaft, the handle freely rotates about the tool shaft in a plane perpendicular to the tool shaft. When the faceted second section receives the multiple facets of the second end of the tool shaft, the handle is adjustably rotatable to multiple locking positions about the shaft in a plane perpendicular to the shaft. The lock includes threads mated to threads in an opening in the shaft or lugs mated to recesses in the opening in the shaft.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a hand tool of the present invention;

FIG. 2 is an illustration of the use of a hand tool of the present invention;

FIG. 3 is a close-up perspective view of a handle on a hand tool of the present invention;

FIG. 4 is a close-up front view of a handle on a hand tool of the present invention;

FIG. 5 is a close-up exploded view of a handle on a hand tool of the present invention;

FIG. 6 is a close-up exploded view of a handle on a hand tool of the present invention;

FIG. 7 is a partial cross-sectional exploded view of a handle on a hand tool of the present invention;

FIG. 8 is a partial cross-sectional exploded view of a handle on a hand tool of the present invention;

FIG. 9 is a top view of a hand tool of the present invention illustrating the free rotation feature thereof;

FIG. 10 is a partial cross-sectional exploded view of a handle on a hand tool of the present invention;

FIG. 11 is a partial cross-sectional exploded view of a handle on a hand tool of the present invention; and

FIG. 12 is a top view of a hand tool of the present invention illustrating the multi-position locking rotation feature thereof.

### DETAILED DESCRIPTION OF THE PREFERRED EMBODIMENTS

As shown in the exemplary drawings, for purposes of illustration, the present invention is directed to a hand tool, generally referred to by reference numeral 20, with a novel swiveling/adjustable handle. The present invention was specifically designed with the hand tool 20 being a hand-held scraper but may find application in other types of hand tools.

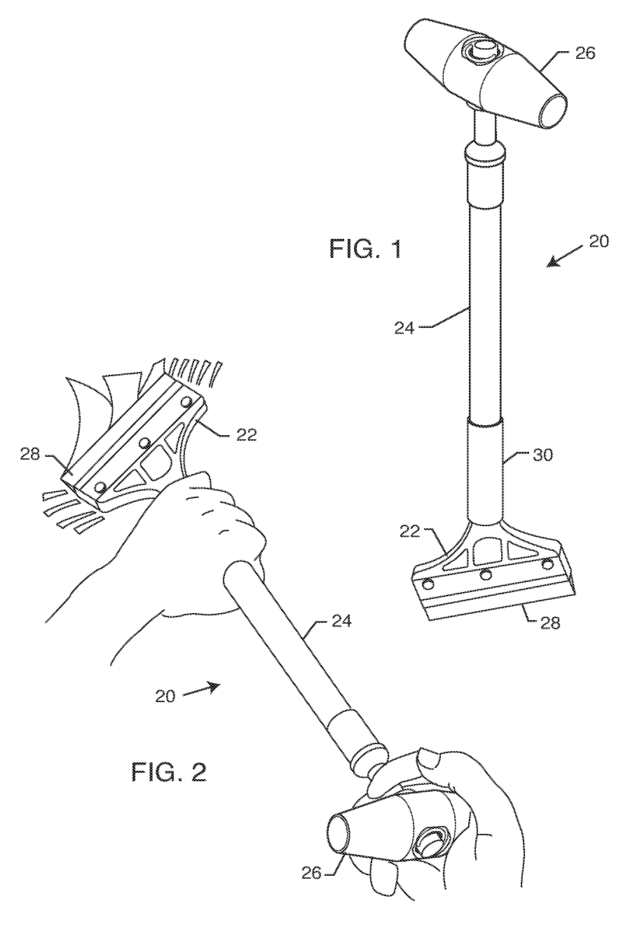

As shown in FIGS. 1 and 2, the hand tool 20 consists primarily of a tool head 22 attached to one end of a shaft 24 with a handle 26 attached to the other end of the shaft 24. The tool head 22 includes a thin, razor-like blade 28 with a narrow margin of the blade 28 exposed. The blade 28 is typically a steel, double-edged blade about three to five inches long, such as are commercially available for prior art scraping tools. The tool head 22 is typically a die-cast metal piece, which provides a desirable combination of adequate strength and low cost for holding the blade 28. In the alternative, the tool head 22 may comprise a molded, high strength plastic or reinforced plastic piece, an assembly of stamped metal pieces, or a machined metal piece.

The shaft 24 extends from a bushing 30 that is preferably integral with the tool head 22. The shaft 24 is typically between about six inches and thirty inches long. In a particularly preferred embodiment, the shaft 24 is about eighteen inches long. The shaft 24 is preferably made from a piece of metal, such as steel or aluminum, either solid or hollow tubing with a smooth exterior wall.

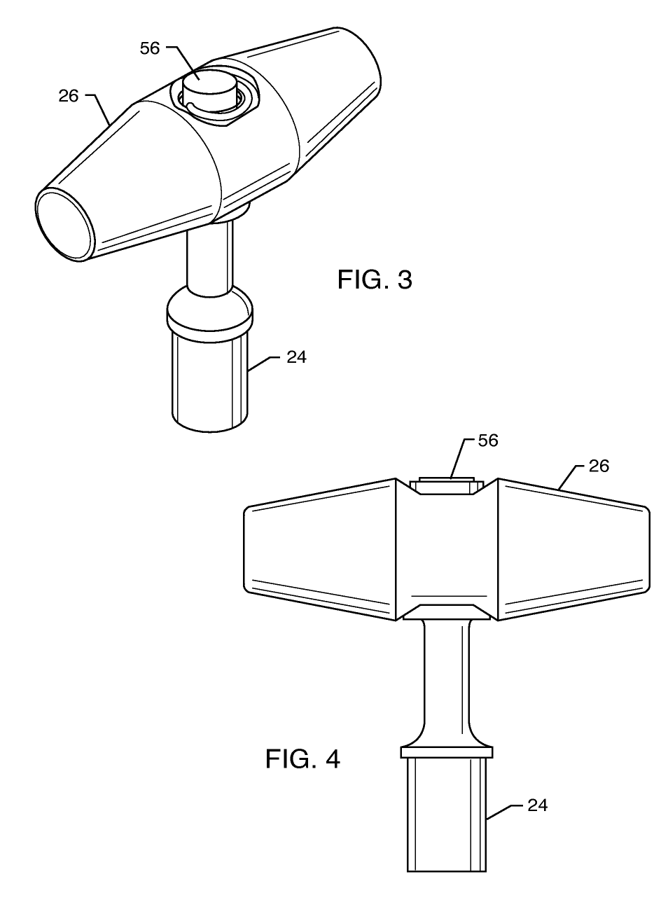

As shown more clearly in FIGS. 3 and 4, the handle 26 is a relatively narrow oblong piece of material that may be easily grasped by a hand. The handle 26 is designed to carry the dynamic load of the tool 20 during use. Suitable materials for the handle 26 include plastic such as nylon, ABS (acrylonitrile butadiene styrene), and like materials, particularly when reinforced. More durable handles 26 may be provided, comprised of die-cast or machined metals, such as aluminum, that are coated with a rubberized plastic for enhanced grip and comfort.

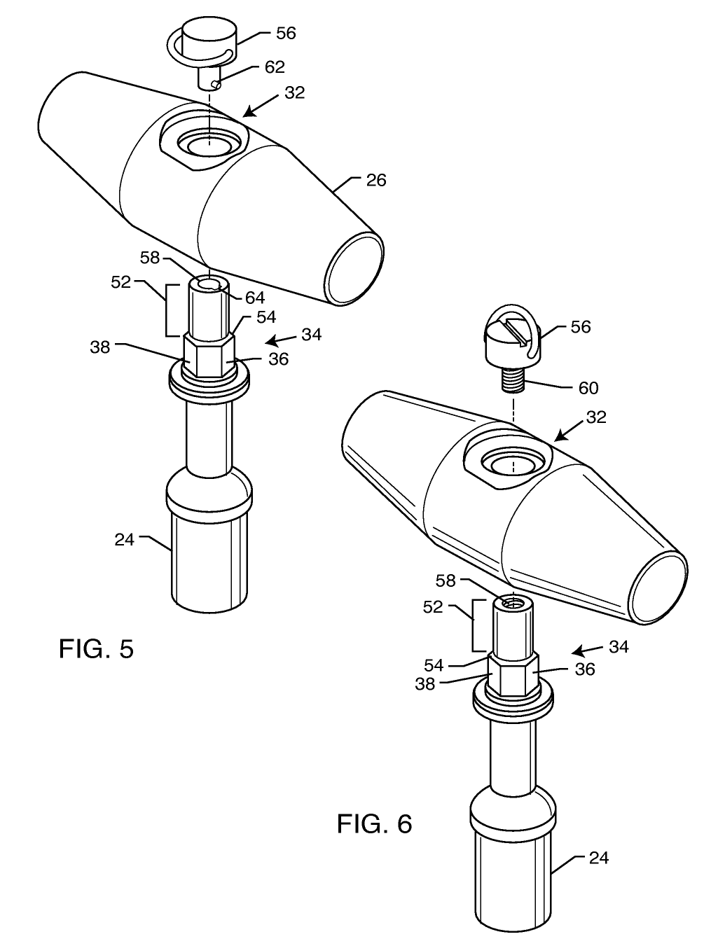

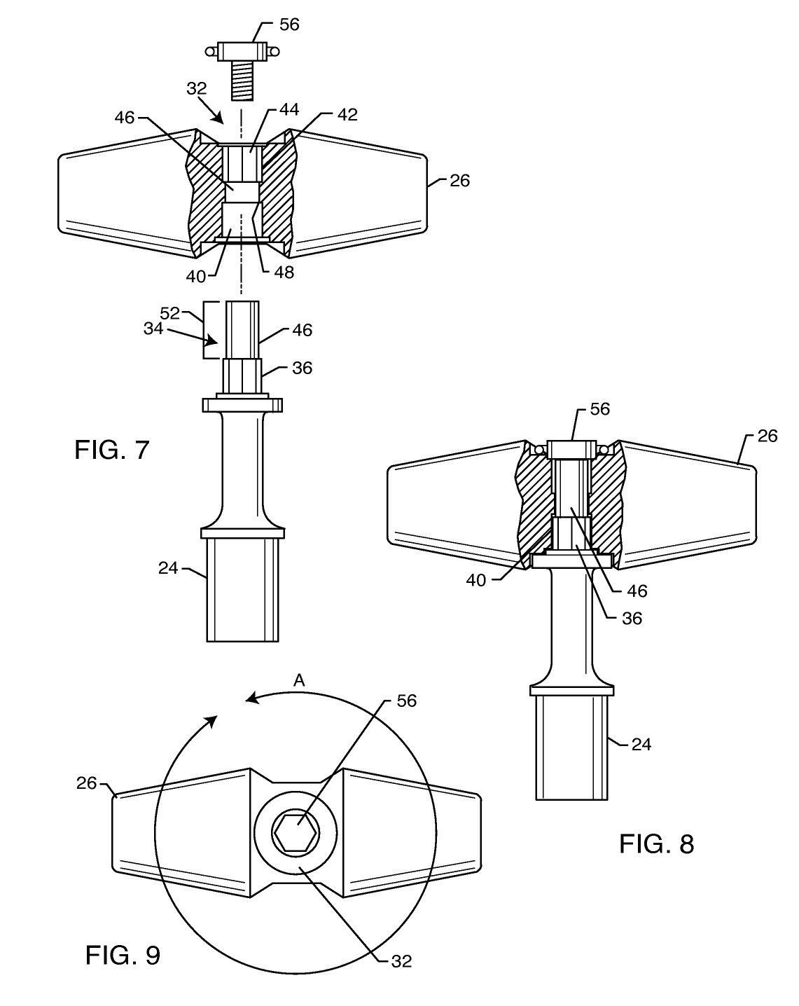

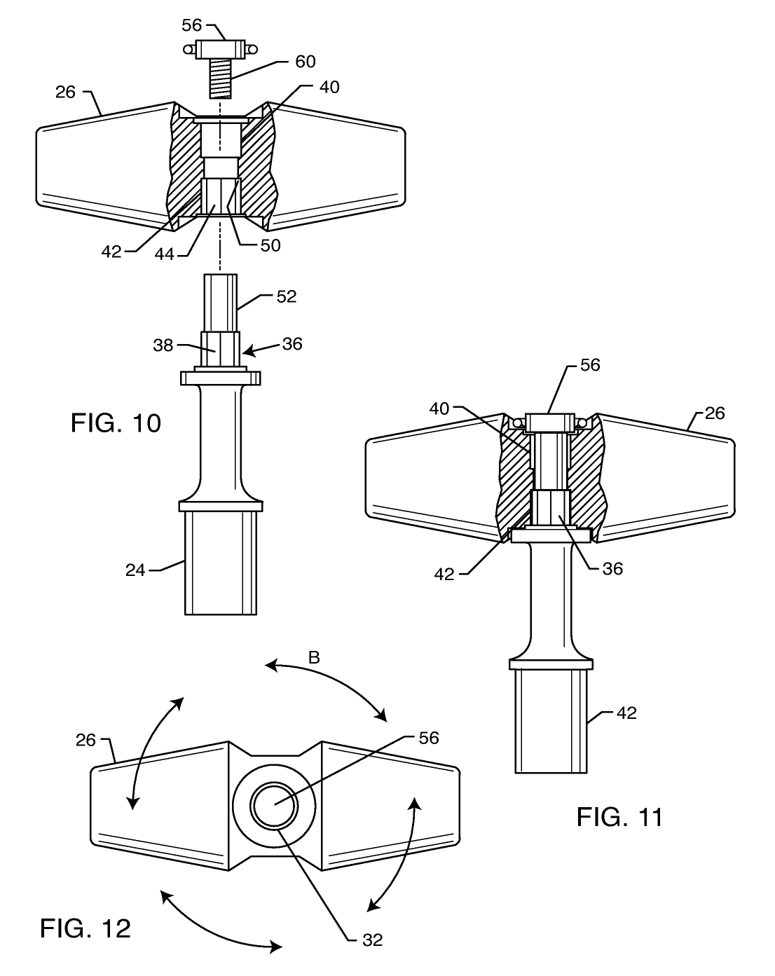

As illustrated in FIGS. 5-8 and 10-11, the shaft 24 is mounted perpendicularly and directly into a bore 32 through the center of the handle 26. The bore 32 through the handle 26 is configured for receiving a stem 34 on the end of the shaft 24. The stem 34 includes a faceted portion 36 in which the perimeter of the stem 34 is segmented into three or more outwardly oriented faces 38. The remainder of the stem 34 is preferably smooth and cylindrical as illustrated in FIGS. 5 and 6, but may be faceted as well.

The bore 32 includes a cylindrical section 40 at one end thereof and a coaxial, faceted section 42 at the other end. The handle 26 may be attached to the stem 34 through either end of the bore 32. In this way, either the cylindrical section 40 or the faceted section 42 will surround the stem 34 and engage the faceted portion 36 thereof. If the cylindrical section 40 is the portion of the bore 32 that engages the faceted portion 36, then the handle 26 will freely rotate about the stem 34 as shown by arrow A in FIG. 9. The surface of the cylindrical section 40 should be formed or machined smooth so that any contact between the cylindrical section 40 and the faceted portion 36 is essentially frictionless, allowing free rotation of the handle 26 about the stem 34.

The faceted section 42 of the bore 32 includes three or more inwardly oriented faces 44. The number of faces 44 in the faceted section 42 preferably equals the number of faces 38 on the faceted portion 36 or is some multiple thereof, such that matching faces 38, 44 can engage and lock the handle 26 at a particular rotational angle with respect to the stem 34 as shown by arrows B in FIG. 12. The rotational angle of the handle 26 with respect to the stem 34 may be changed by lifting the handle such that the faces 38 no longer engage the faces 44. The handle 26 may then be rotated to a different position and lowered back onto the stem 34 such that the faces 38 again engage the faces 44.

To switch between a freely rotating configuration or a locked rotation configuration, the handle 26 may be completely removed from the stem 34 and rotated 180° so as to switch between the cylindrical section 40 or the faceted section 42 engaging the stem 34 of the shaft 24. The interior of the bore 32 may include a narrower central section 46 such that a first interior shoulder 48 is adjacent to the cylindrical section 40 and a second interior shoulder 50 is adjacent to the faceted section 42. Similarly, the stem 34 may have a relatively narrower section 52 such that an exterior shoulder 54 is defined adjacent to the faceted portion 36. When the handle 26 is attached to the stem 34, either the first or second interior shoulders 48, 50 would engage the exterior shoulder 54. The surfaces of these shoulders 48, 50, 54 are all formed or machined smooth so as to create an essentially frictionless surface.

A lock or locking pin 56 is removably attached to the stem 34 so as to secure the handle 26 when attached. The lock 56 may be secured to an opening 58 in the end of the stem 34 and may be secured by mating threads 60, lugs 62 and recesses within the opening 58, or other commonly known methods of securing. When the locking pin 56 is secured in the opening 58, the pin 56 will secure the handle 26 against the stem 34.

Although several embodiments have been described in detail for purposes of illustration, various modifications may be made without departing from the scope and spirit of the invention. Accordingly, the invention is not to be limited, except as by the appended claims.

What is claimed is:

1. A hand tool, comprising:
a tool head;
a tool shaft having a first end attached to the tool head and a faceted second end;
a handle selectively and adjustably attached to a second end of the tool shaft, the handle including a bore for receiving the second end of the tool shaft, the bore comprising a cylindrical first section for receiving the second end of the tool shaft in a manner preventing rotation of the handle relative to the tool shaft, and a co-axial, faceted second section for alternatively receiving the second end of the tool shaft in a manner preventing rotation of the handle relative to the tool shaft; and
a lock for releasably securing the handle to the second end of the tool shaft.

2. The hand tool of claim 1, wherein the tool head comprises a scraper.

3. The hand tool of claim 1, wherein the cylindrical first section defines a first interior shoulder, the faceted second section defines a second interior shoulder and the second end of the tool shaft defines an exterior shoulder.

4. The hand tool of claim 3, wherein the first interior shoulder engages the exterior shoulder when the cylindrical first section receives the second end of the tool shaft.

5. The hand tool of claim 3, wherein the second interior shoulder engages the exterior shoulder when the faceted second section receives the second end of the tool shaft.

6. The hand tool of claim 1, wherein the handle is comprised of plastic, reinforced plastic, die-cast metal or machined metal.

7. The hand tool of claim 6, wherein the handle is comprised of nylon or ABS plastic.

8. The hand tool of claim 6, wherein the handle is comprised of aluminum coated with a rubberized plastic.

9. The hand tool of claim 1, wherein the handle freely rotates about the shaft in a plane perpendicular to the shaft when the cylindrical first section receives the second end of the tool shaft.

10. The hand tool of claim 1, wherein the handle is adjustably rotatable to multiple locking positions about the shaft in a plane perpendicular to the shaft when the faceted second section receives the second end of the tool shaft.

11. The hand tool of claim 10, wherein the lock includes threads mated to threads in an opening in the shaft or lugs mated to recesses in the opening in the shaft.

12. A hand tool, comprising:
a tool head;
a tool shaft having a first end attached to the tool head and a faceted second end;
a handle selectively and adjustably attached to a second end of the tool shaft, the handle including a bore for receiving the second end of the tool shaft, the bore comprising a cylindrical first section for receiving the second end of the tool shaft, wherein the handle freely rotates about the shaft in a plane perpendicular to the shaft, and a co-axial, faceted second section for alternatively receiving the second end of the tool shaft, wherein the handle is adjustably rotatable to multiple locking positions about the shaft in a plane perpendicular to the shaft; and
a lock for releasably securing the handle to the second end of the tool shaft.

13. The hand tool of claim 12, wherein the cylindrical first section defines a first interior shoulder, the faceted second section defines a second interior shoulder and the second end of the tool shaft defines an exterior shoulder;
wherein the first interior shoulder engages the exterior shoulder when the cylindrical first section receives the second end of the tool shaft; and
wherein the second interior shoulder engages the exterior shoulder when the faceted second section receives the second end of the tool shaft.

14. The hand tool of claim 12, wherein the handle is comprised of nylon or ABS plastic or reinforced plastic, or die-cast or machined aluminum coated with rubberized plastic.

15. The hand tool of claim 12, wherein the lock includes threads mated to threads in an opening in the shaft or lugs mated to recesses in the opening in the shaft.

16. The hand tool of claim 12, wherein the tool head comprises a scraper.

17. A hand tool, comprising:
a tool head;
a tool shaft having a first end attached to the tool head and a faceted second end;
a handle selectively and adjustably attached to a second end of the tool shaft, the handle including a bore for receiving the second end of the tool shaft, the bore comprising a cylindrical first section for receiving the second end of the tool shaft in a manner permitting rotation of the handle relative to the tool shaft, and a co-axial, faceted second section for alternatively receiving the second end of the tool shaft in a manner preventing rotation of the handle relative to the tool shaft;
wherein the cylindrical first section defines a first interior shoulder, the faceted second section defines a second interior shoulder and the second end of the tool shaft defines an exterior shoulder;
wherein the first interior shoulder engages the exterior shoulder when the cylindrical first section receives the second end of the tool shaft;
wherein the second interior shoulder engages the exterior shoulder when the faceted second section receives the second end of the tool shaft; and
a lock for releasably securing the handle to the second end of the tool shaft.

18. The hand tool of claim 17, wherein the handle freely rotates about the shaft in a plane perpendicular to the shaft when the cylindrical first section receives the second end of the tool shaft;
wherein the handle is adjustably rotatable to multiple locking positions about the shaft in a plane perpendicular to the shaft when the faceted second section receives the second end of the tool shaft; and
wherein the lock includes threads mated to threads in an opening in the shaft or lugs mated to recesses in the opening in the shaft.

19. The hand tool of claim 17, wherein the handle is comprised of nylon or ABS plastic or reinforced plastic, or die-cast or machined aluminum coated with rubberized plastic.

20. The hand tool of claim 17, wherein the tool head comprises a scraper.
